(19) United States
(12) Patent Application Publication
(10) Pub. No.: US 2026/0277415 A1
(43) Pub. Date: Sep. 17, 2026

(54) DISPLAY CONTROL DEVICE

(71) Applicant: TOYOTA JIDOSHA KABUSHIKI KAISHA, Toyota-shi (JP)

(72) Inventors: Kohei MAEJIMA, Nagakute-shi (JP); Yuki Yamamoto, Nagakute-shi (JP)

(73) Assignee: TOYOTA JIDOSHA KABUSHIKI KAISHA, Toyota-shi (JP)

(21) Appl. No.: 19/541,700

(22) Filed: Feb. 17, 2026

(30) Foreign Application Priority Data
Mar. 17, 2025 (JP) 2025-042193

(51) Int. Cl. G06F 3/04845; G06F 3/0488

(52) U.S. Cl. CPC G06F 3/04845; G06F 3/0488

(57) ABSTRACT

A display control device is mounted on a vehicle and controls a touch panel that receives a touch operation from a user of the vehicle. The display control device includes an operation amount adjustment unit that adjusts a movement amount of an image within a screen by the touch operation based on a converted operation amount obtained by converting an operation amount of the touch operation according to a predetermined reference screen size and a screen size of the touch panel, and a display control unit that causes the touch panel to display the image such that the image moves within the screen of the touch panel according to the movement amount that is adjusted.

### CROSS-REFERENCE TO RELATED APPLICATION

This application claims priority to Japanese Patent Application No. 2025-042193 filed on Mar. 17, 2025. The disclosure of the above-identified application, including the specification, drawings, and claims, is incorporated by reference herein in its entirety.

### BACKGROUND

### 1. Technical Field

The present disclosure relates to a display control device.

### 2. Description of Related Art

It is known that, in an information processing device including a touch panel device, a physical operation determined by a correspondence relationship with physical information indicated by touch panel information including touch position coordinates is applied to an object and displayed (for example, Japanese Unexamined Patent Application Publication No. 05-100809 (JP 05-100809 A)).

### SUMMARY

Meanwhile, in a display unit such as a general touch panel, predetermined normalization may be performed on an operation amount of a touch operation from a user according to a screen size of the display unit with respect to a predetermined reference screen size. The operation amount of the touch operation refers to a physical movement amount of a finger on a screen surface. As the normalization, for example, in order for an image to move by the same movement amount within the screen of the display unit, the operation amount of the touch operation may be set to be small when the screen size is smaller than the reference screen size, and may be set to be large when the screen size is larger than the reference screen size. However, a dimension of the finger of the user on the actual screen surface is independent of the screen size. Therefore, the operability may become such that the user feels a sense of discomfort due to the relationship between the physical movement amount of the finger on the screen surface and the movement amount of the image within the screen of the display unit.

A display control device according to an aspect of the present disclosure is a display control device that is mounted on a vehicle and configured to control a display unit that receives a touch operation from a user of the vehicle, the display control device including:

an operation amount adjustment unit configured to adjust a movement amount of an image within a screen of the display unit by the touch operation based on a converted operation amount obtained by converting an operation amount of the touch operation according to a predetermined reference screen size and a screen size of the display unit; and a display control unit configured to cause the display unit to display the image such that the image moves within the screen of the display unit according to the movement amount that is adjusted.

In the display control device according to the aspect of the present disclosure, the movement amount of the image within the screen by the touch operation is adjusted based on the converted operation amount and the screen size of the display unit. As a result, even when the screen size of the display unit differs from the reference screen size, the movement amount can be adjusted according to the screen size of the display unit to reduce a sense of discomfort for the user, as compared with when the converted operation amount is directly used as the movement amount. Therefore, according to the display control device according to the aspect of the present disclosure, it is possible to suppress deterioration in operability that may occur due to the relationship between the physical movement amount of the finger on the screen surface and the movement amount of the image within the screen of the display unit.

In one embodiment, the operation amount adjustment unit may be configured to store a screen size coefficient that is a correction coefficient proportional to the screen size of the display unit, and adjust the movement amount such that a value obtained by multiplying the converted operation amount by the screen size coefficient is the movement amount.

In one embodiment, the operation amount adjustment unit may be configured to set, when a magnitude of an operation speed of the touch operation is equal to or less than a speed threshold value that is predetermined, the screen size coefficient to be small, as compared with when the magnitude of the operation speed is larger than the speed threshold value.

In one embodiment, the operation amount adjustment unit may be configured to set, when a magnitude of an operation intensity of the touch operation is larger than an intensity threshold value that is predetermined, the screen size coefficient to be small, as compared with when the magnitude of the operation intensity is equal to or less than the intensity threshold value.

In one embodiment, the operation amount adjustment unit may be configured to set, when a magnitude of an operation frequency of the touch operation, in which the user repeatedly swipes a surface of the screen in the same direction, is larger than a frequency threshold value that is predetermined, the screen size coefficient to be large, as compared with when the operation frequency is equal to or less than the frequency threshold value.

According to the display control device according to some aspects of the present disclosure, it is possible to suppress deterioration in operability that may occur due to the relationship between the physical movement amount of the finger on the screen surface and the movement amount of the image on the screen of the display unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a display control device according to an embodiment;

FIG. 2A is a schematic diagram showing an operation amount of a touch operation, a converted operation amount, and a movement amount after adjustment in a display unit having a reference screen size;

FIG. 2B is a schematic diagram showing an operation amount of a touch operation, a converted operation amount, and a movement amount after adjustment in a display unit having a screen size smaller than the reference screen size;

FIG. 2C is a schematic diagram showing an operation amount of a touch operation, a converted operation amount, and a movement amount after adjustment in a display unit having a screen size larger than the reference screen size;

FIG. 3 is a flowchart showing processing by the display control device of FIG. 1;

FIG. 4A is a schematic diagram for describing a comparison example of conversion in a display unit having a reference screen size;

FIG. 4B is a schematic diagram for describing a comparison example of conversion in a display unit having a screen size smaller than the reference screen size; and

FIG. 4C is a schematic diagram for describing a comparison example of conversion in a display unit having a screen size larger than the reference screen size.

### DETAILED DESCRIPTION OF EMBODIMENTS

Hereinafter, the embodiment will be described in detail with reference to the accompanying drawings. The same or corresponding elements in the drawings are denoted by the same reference numerals, and redundant description thereof will be omitted.

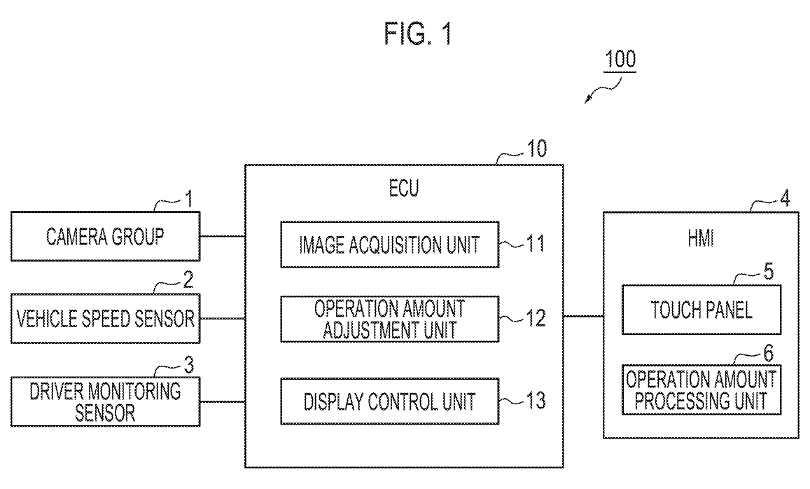

FIG. 1 is a block diagram showing a display control device according to an embodiment. The display control device 100 is mounted on a vehicle. The display control device 100 is a device for controlling a touch panel 5 (display unit) that receives a touch operation from a user of the vehicle.

As shown in FIG. 1, the display control device 100 includes a camera group 1, a vehicle speed sensor 2, a driver monitoring camera 3, a human machine interface (HMI) 4, and an electronic control unit (ECU) 10.

The camera group 1 is a plurality of cameras that capture images of the periphery of the vehicle. The camera group 1 includes, for example, a front camera, a rear camera, and a pair of left and right side view cameras. The front camera is provided, for example, on a front bumper of the vehicle, and captures an image of the periphery of the front of the vehicle. The rear camera is provided, for example, on a rear bumper of the vehicle, and captures an image of the periphery of the rear of the vehicle. The side view camera is provided, for example, in the vicinity of a door mirror of the vehicle, and captures an image of the periphery of the side of the vehicle. The camera group 1 has, for example, a wide angle of view and can also capture an image of the vehicle body. The camera group 1 transmits a captured image related to the periphery of the vehicle to the ECU 10. The camera group 1 is not essential.

The vehicle speed sensor 2 is a detector that detects the speed of the vehicle. A known vehicle speed sensor can be used as the vehicle speed sensor 2. The vehicle speed sensor 2 transmits the detected vehicle speed information to the ECU 10.

The driver monitoring camera 3 is a camera for capturing an image of a face of a passenger (user) such as a driver. The driver monitoring camera 3 is provided, for example, on a center cluster of the vehicle, facing toward the rear of the vehicle. The driver monitoring camera 3 may be provided in plurality to capture an image of the passenger from a plurality of directions. The driver monitoring camera 3 transmits the captured image of the passenger to the ECU 10.

The HMI 4 is an interface for inputting and outputting information between the ECU 10 and the passenger. The HMI 4 includes the touch panel 5 provided in a vehicle cabin. The HMI 4 performs image output of the touch panel 5 in response to a control signal from the ECU 10. The touch panel 5 may be a center display or a display for navigation.

The touch panel 5 receives a touch operation from the passenger. The touch operation includes, for example, a swipe operation of moving a position of an image within a screen displayed on the touch panel 5. The touch operation is an operation of physically moving a part of the body of the user, such as a finger, on the screen surface of the touch panel 5.

The HMI 4 includes, for example, an operation amount processing unit 6 that recognizes and calculates an operation amount of the touch operation from the passenger. The operation amount of the touch operation means a physical movement amount of a finger or the like on the screen surface.

The operation amount processing unit 6 performs predetermined normalization on the operation amount of the touch operation from the user (the physical movement amount of a finger on the screen surface) according to the screen size of the display unit with respect to a predetermined reference screen size.

The predetermined reference screen size is a screen size that serves as a reference for normalizing the operation amount of the touch operation between display units having different screen sizes. The predetermined reference screen size can be, for example, 10 inches. The screen size of the touch panel 5 here is, for example, any of 8 inches or 14 inches as will be described later. Here, the touch panel 5 is considered to have different screen sizes with the same aspect ratio for simplicity of the description. Therefore, when the same image is displayed on the screen, a ratio of physical dimensions of the image on the screen surface becomes the same as a ratio of inch sizes.

The predetermined normalization is processing of increasing or decreasing the operation amount of the touch operation in advance by a normalization coefficient according to a ratio of screen sizes in a touch panel having a screen size different from the reference screen size. The operation amount of the touch operation is the operation amount of the touch operation required to move the images within the screen by equal movement amounts. In the predetermined normalization, the operation amount of the touch operation is reduced on a touch panel having a screen size smaller than the reference screen size, and the operation amount of the touch operation is increased on a touch panel having a screen size larger than the reference screen size.

As a specific example of the predetermined normalization, for example, an example in which the movement amount of the image within the screen is 100 mm when the operation amount of the touch operation is 100 mm on a touch panel having a reference screen size of 10 inches is used as a reference. In this case, the ratio of the screen size of the touch panel having a screen size of 8 inches is 0.8. Therefore, normalization is conceivable in which a normalization coefficient is set to 8/10 such that the operation amount of the touch operation required for the movement amount of the image within the screen to be 100 mm is 80 mm. For a touch panel with a screen size of 14 inches, the ratio of the screen size is 1.4. Therefore, normalization is conceivable in which a normalization coefficient is set to 14/10 such that the operation amount of the touch operation required for the movement amount of the image within the screen to be 100 mm is 140 mm.

The operation amount processing unit 6 calculates the converted operation amount obtained by converting the operation amount of the touch operation according to a predetermined reference screen size, based on the operation amount of the touch operation from the user on touch panel 5 and detected on the touch panel 5. The operation amount of the touch operation refers to a physical movement amount of a finger on a screen surface. The converted operation amount means the operation amount that has been converted to calculate the movement amount of the image that moves within the screen by the touch operation. The converted operation amount is used to calculate the movement amount of the image that moves within the screen as will be described later.

The operation amount processing unit 6 converts the operation amount of the touch operation into the converted operation amount by, for example, multiplying the operation amount of the touch operation by a reciprocal of the normalization coefficient when normalizing the operation amount of the touch operation so that the movement amount of the image within the screen is the same. The conversion into the converted operation amount is not limited to this example, and may be any calculation corresponding to an inverse conversion of the normalization performed to output the movement amount of the image that moves within the screen based on the operation amount of the touch operation as an input.

When the predetermined normalization is performed as described above, the operation amount processing unit 6 may calculate, for the touch panel having a screen size of 8 inches, the converted operation amount of 100 mm with respect to the operation amount of 80 mm of the touch operation. When the predetermined normalization is performed as described above, the operation amount processing unit 6 may calculate, for the touch panel having a screen size of 14 inches, the converted operation amount of 100 mm with respect to the operation amount of 125 mm of the touch operation.

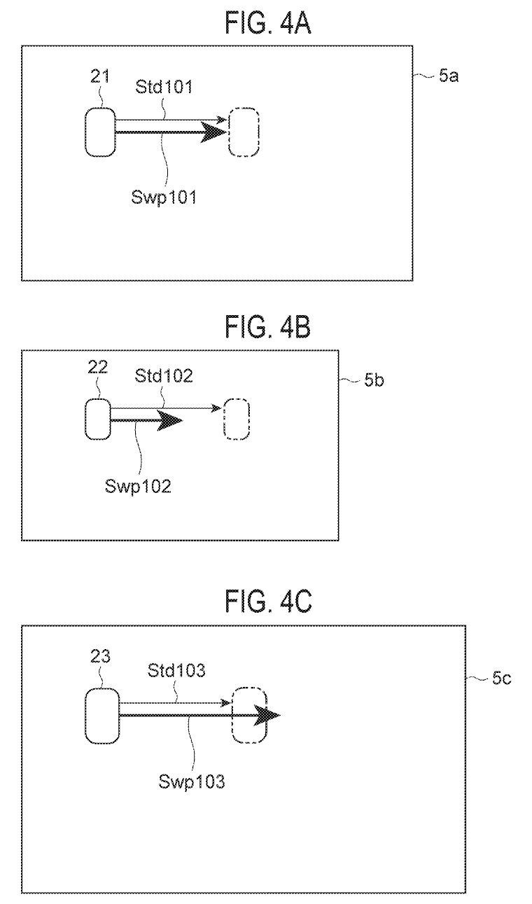

For example, FIGS. 4A-4C show a relationship between the touch operation and the converted operation amount when the predetermined normalization is performed. The touch panel 5a of FIG. 4A has a screen size of 10 inches, the touch panel 5b of FIG. 4B has a screen size of 8 inches, and the touch panel 5c of FIG. 4C has a screen size of 14 inches.

In FIGS. 4A-4C, a thick arrow indicates an operation of swiping the surface of the touch panel with a finger as the touch operation from the user, and a thin arrow indicates the converted operation amount corresponding to the swipe operation.

In the example of FIG. 4A, the screen size of the touch panel 5a is 10 inches and is the same size as the reference screen size. In the predetermined normalization, the operation amount of the touch operation is normalized, for example, to require one time the movement amount of the image that moves within the screen by the touch operation (normalization coefficient: 1.0). Therefore, when the user performs the swipe operation Swp101, the converted operation amount Std101 is calculated by a value of 1 times (reciprocal of the normalization coefficient) the operation amount of the swipe operation Swp101. For example, when the operation amount of the swipe operation Swp101 is 100 mm, the converted operation amount Std101 is also 100 mm.

In the example of FIG. 4B, the screen size of the touch panel 5b is 8 inches and is a size smaller than the reference screen size. In the predetermined normalization, the operation amount of the touch operation is normalized, for example, to require 0.8 time the movement amount of the image that moves within the screen by the touch operation (normalization coefficient: 0.8). Therefore, when the user performs the swipe operation Swp102, the converted operation amount Std102 is calculated by a value of 10/8 times (reciprocal of the normalization coefficient) the operation amount of the swipe operation Swp102. For example, when the operation amount of the swipe operation Swp102 is 80 mm, the converted operation amount Std102 is 100 mm.

In the example of FIG. 4C, the screen size of the touch panel 5c is 14 inches and is a size larger than the reference screen size. In the predetermined normalization, the operation amount of the touch operation is normalized, for example, to require 1.4 time the movement amount of the image that moves within the screen by the touch operation (normalization coefficient: 1.4). Therefore, when the user performs the swipe operation Swp103, the converted operation amount Std103 is calculated by a value of 10/14 times (reciprocal of the normalization coefficient) the operation amount of the swipe operation Swp103. For example, when the operation amount of the swipe operation Swp103 is 140 mm, the converted operation amount Std103 is 100 mm.

The ECU 10 is an electronic control unit including a central processing unit (CPU) and a storage unit. The storage unit is configured of, for example, a read only memory (ROM), a random access memory (RAM), and an electrically erasable programmable read-only memory (EEPROM). In the ECU 10, for example, various functions are realized by the CPU executing a program stored in the storage unit. The ECU 10 may be configured of a plurality of electronic units.

As a functional configuration, the ECU 10 includes an image acquisition unit 11, an operation amount adjustment unit 12, and a display control unit 13.

The image acquisition unit 11 acquires an image to be displayed on the touch panel 5. The image acquisition unit 11 acquires an image that can be moved in position or orientation within the screen of the touch panel 5 by the touch operation (for example, the swipe operation) from the user.

The image acquisition unit 11 may acquire, for example, a map image for car navigation as the image. In the map image for car navigation, a range of the map displayed within the screen can be changed by the swipe operation of the user. The image acquisition unit 11 may acquire, for example, a composite vehicle image representing the vehicle as seen from a virtual viewpoint as the image. The composite vehicle image is a 3D image generated by combining the captured images from a plurality of cameras that capture an image of the periphery of the vehicle captured by the camera group 1. The composite vehicle image allows the position or orientation of the composite vehicle displayed on the screen can be changed by the swipe operation of the user. As an image, the present disclosure is not limited to these examples, and may be any image for which the position or orientation within the screen of the touch panel 5 can be moved by a touch operation from the user.

The operation amount adjustment unit 12 adjusts the movement amount of the image within the screen by the touch operation based on the converted operation amount obtained by converting the operation amount of the touch operation based on the predetermined reference screen size and the screen size of the touch panel 5. The operation amount adjustment unit 12 calculates an adjusted movement amount by multiplying the converted operation amount converted as described above by the operation amount processing unit 6 by the screen size coefficient, and adjusts the movement amount. The adjusted movement amount is a value after the movement amount of the image within the screen by the touch operation is adjusted. The screen size coefficient is a correction coefficient proportional to the screen size of the touch panel 5. The screen size coefficient may be stored in the operation amount adjustment unit 12 as a plurality of parameters corresponding to the screen sizes of the plurality of touch panels 5. The screen size coefficient may be calculated by the operation amount adjustment unit 12 based on the screen size of the acquired touch panel 5 and the reference screen size.

The operation amount adjustment unit 12 determines the screen size coefficient corresponding to the screen size of the touch panel 5 based on the acquired screen size of the touch panel 5. The operation amount adjustment unit 12 may acquire the screen size of the touch panel 5 by the user manually inputting the screen size of the connected touch panel 5. The operation amount adjustment unit 12 may acquire the screen size of the touch panel 5 from an input signal from the connected touch panel 5. When the screen size coefficient is calculated by the operation amount adjustment unit 12, the operation amount adjustment unit 12 may acquire the reference screen size by the user manually inputting the reference screen size to the touch panel 5.

For example, when the screen size of the touch panel 5 is 10 inches, the operation amount adjustment unit 12 determines the screen size coefficient to be 1.0. When the screen size of the touch panel 5 is 8 inches, the operation amount adjustment unit 12 may determine the screen size coefficient to be 8/10. When the screen size of the touch panel 5 is 14 inches, the operation amount adjustment unit 12 may determine the screen size coefficient to be 14/10.

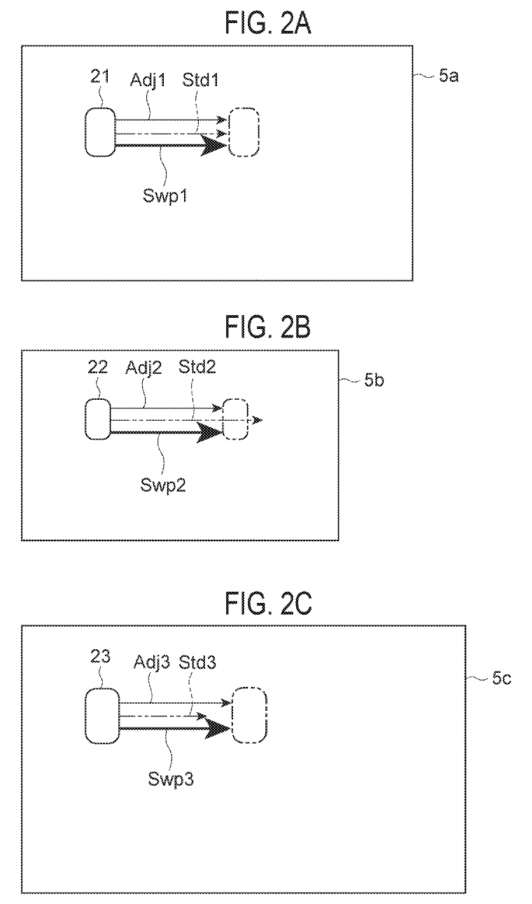

As a specific example, for example, FIGS. 2A-2C show a relationship between the touch operation, the converted operation amount, and the adjusted movement amount. The touch panel 5a of FIG. 2A has a screen size of 10 inches, the touch panel 5b of FIG. 2B has a screen size of 8 inches, and the touch panel 5c of FIG. 2C has a screen size of 14 inches.

In FIGS. 2A-2C, a thick arrow indicates an operation of swiping the surface of the touch panel with a finger as the touch operation from the user. In addition, a thin two-dot chain line arrow indicates the converted operation amount corresponding to the swipe operation, and a thin solid line arrow indicates the adjusted movement amount obtained by adjusting the converted operation amount.

In the example of FIG. 2A, the screen size of the touch panel 5a is 10 inches and is the same size as the reference screen size. When the user performs the swipe operation Swp1, the converted operation amount Std1 is calculated by a value of 1 times (reciprocal of the normalization coefficient) the operation amount of the swipe operation Swp1. Further, the adjusted movement amount Adj1 is calculated by a value of 1 times (screen size coefficient) the converted operation amount Std1. When the screen size is 10 inches and the operation amount of the swipe operation Swp1 is 100 mm, the converted operation amount Std1 is also 100 mm, and the adjusted movement amount Adj1 is also 100 mm.

In the example of FIG. 2B, the screen size of the touch panel 5b is 8 inches and is a size smaller than the reference screen size. When the user performs the swipe operation Swp2, the converted operation amount Std2 is calculated by a value of 10/8 times (reciprocal of the normalization coefficient) the operation amount of the swipe operation Swp2. Further, the adjusted movement amount Adj2 is calculated by a value of 0.8 times (screen size coefficient) the converted operation amount Std2. When the screen size is 8 inches and the operation amount of the swipe operation Swp2 is 100 mm, the converted operation amount Std2 is 125 mm, and the adjusted movement amount Adj2 is 100 mm. As a result, when the user performs the touch operation with the operation amount of 100 mm (physical movement amount of a finger on the screen surface), the movement amount of the image within the screen is equal to 100 mm regardless of whether the screen size is 10 inches or 8 inches.

In the example of FIG. 2C, the screen size of the touch panel 5c is 14 inches and is a size larger than the reference screen size. When the user performs the swipe operation Swp3, the converted operation amount Std3 is calculated by a value of 10/14 times (reciprocal of the normalization coefficient) the operation amount of the swipe operation Swp3. Further, the adjusted movement amount Adj3 is calculated by a value of 1.4 times (screen size coefficient) the converted operation amount Std3. When the screen size is 14 inches and the operation amount of the swipe operation Swp3 is 100 mm, the converted operation amount Std3 is 71 mm, and the adjusted movement amount Adj3 is 100 mm. As a result, when the user performs the touch operation with the operation amount of 100 mm (physical movement amount of a finger on the screen surface), the movement amount of the image on the screen is equal to 100 mm regardless of whether the screen size is 10 inches or 14 inches.

The operation amount adjustment unit 12 may adjust the movement amount according to the magnitude of the operation speed of the touch operation from the user. The operation amount adjustment unit 12 may set the screen size coefficient to be small, when the magnitude of the operation speed of the touch operation from the user is equal to or less than a predetermined speed threshold value, as compared with when the magnitude of the operation speed is larger than the speed threshold value. The speed threshold value is a threshold value of the magnitude of the operation speed for adjusting the movement amount of the image within the screen according to the magnitude of the operation speed. The speed threshold value can be set in advance based on, for example, a sensory evaluation of the operability when the operation speed of the touch operation from the user is set to several different values.

For example, an example is given when the user performs the touch operation with the operation amount of 100 mm on the touch panel 5 having a screen size of 8 inches by using the screen size of 10 inches as a reference. When the magnitude of the operation speed is equal to or less than the speed threshold value, the operation amount adjustment unit 12 may set the adjusted movement amount to 125 × 0.8 = 100 mm by multiplying the converted operation amount (100/0.8 = 125 mm) by 0.8 (screen size coefficient). When the magnitude of the operation speed is larger than the speed threshold value, the operation amount adjustment unit 12 may set the adjusted movement amount to 125 × 1.0 = 125 mm by multiplying the converted operation amount by 1.0 (screen size coefficient). In this case, by changing the adjusted movement amount within a range of 100 mm to 125 mm according to the operation speed, the operability becomes closer to intuitive operability when the operation speed is fast, and fine adjustment becomes easier when the operation speed is slow.

For example, an example is given when the user performs the touch operation with the operation amount of 100 mm on the touch panel 5 having a screen size of 14 inches by using the screen size of 10 inches as a reference. When the magnitude of the operation speed is equal to or less than the speed threshold value, the operation amount adjustment unit 12 may set the adjusted movement amount to 71 × 1.0 = 71 mm by multiplying the converted operation amount (100/1.4 = 71 mm) by 1.0 (screen size coefficient). When the magnitude of the operation speed is larger than the speed threshold value, the operation amount adjustment unit 12 may set the adjusted movement amount to 71 × 1.4 = 100 mm by multiplying the converted operation amount by 1.4 (screen size coefficient).

The operation amount adjustment unit 12 may change the screen size coefficient according to the operation intensity of the touch operation from the user. The operation intensity of the touch operation means a strength of pressing the touch panel. The operation intensity of the touch operation may be a pressure of pressing the touch panel detected by a pressure-sensitive sensor. The operation intensity of the touch operation may be a contact area of a finger or the like that presses the touch panel detected by a capacitive sensor. The operation amount adjustment unit 12 may set the screen size coefficient to be small, when the operation intensity is larger than a predetermined intensity threshold value, as compared with when the operation intensity is equal to or less than the intensity threshold value. As a result, when the operation intensity is larger than the intensity threshold value, the movement amount of the image that moves within the screen becomes smaller, making fine adjustment easier.

The operation amount adjustment unit 12 may change the screen size coefficient according to the operation frequency of the touch operation from the user. The operation frequency of the touch operation means a frequency (number of times in a unit time) at which the user repeats the same kind of touch operation. The operation amount adjustment unit 12 may, for example, set the screen size coefficient to be large, when a magnitude of an operation frequency of the touch operation, in which the user repeatedly swipes a surface of the screen in the same direction, is larger than a frequency threshold value that is predetermined, as compared with when the operation frequency is equal to or less than the frequency threshold value. As a result, when the operation frequency is larger than the frequency threshold value, the movement amount of the image that moves within the screen becomes large. Therefore, it is possible to suppress the user from feeling stress in further repeating the swipe operation in the same direction and feeling difficulty in the operation or deterioration in the operability, as compared with when the movement amount is not set to be large.

In addition, the operation amount adjustment unit 12 may change the screen size coefficient according to the vehicle speed of the vehicle. The operation amount adjustment unit 12 may change the screen size coefficient according to information related to the user of the vehicle. The information related to the user may be, for example, a seating position of the user, an attribute or a line of sight of the driver. The seating position of the user can be estimated from a movement of a finger when the user performs the touch operation. The attribute and the line of sight of the driver can be estimated based on a captured image from driver monitoring camera 3.

The display control unit 13 causes the touch panel 5 to display the image such that the image moves within the screen of the touch panel 5 according to the movement amount. The display control unit 13 moves the image within the screen of the touch panel 5 according to the adjusted movement amount adjusted by the operation amount adjustment unit 12.

### Operation of Display Control Device

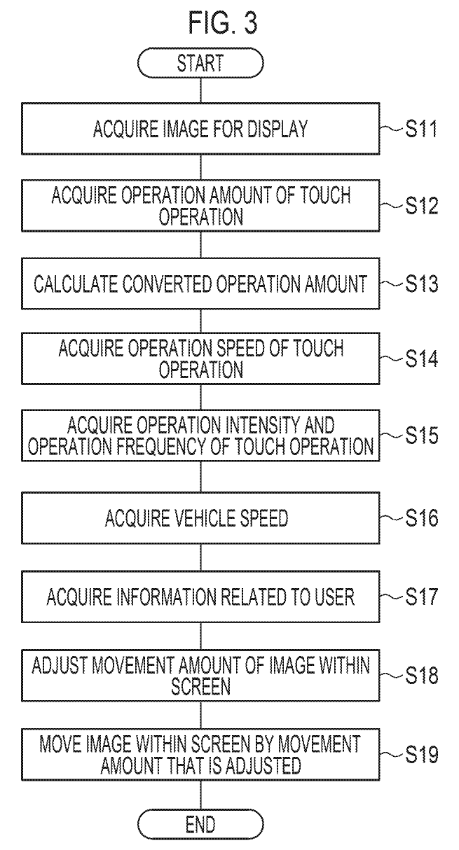

Subsequently, the operation of the display control device 100 will be described with reference to FIG. 3. FIG. 3 is a flowchart showing processing by the display control device of FIG. 1. The processing of the ECU in FIG. 3 is executed, for example, when the power of the ECU 10, the HMI 4, and the like is turned on.

As shown in FIG. 3, in S11, the ECU 10 acquires the image for display by the image acquisition unit 11. The image acquisition unit 11 acquires the image for display on the touch panel 5 based on, for example, the captured images from the camera group 1.

In S12, the operation amount processing unit 6 acquires the operation amount of the touch operation detected by the touch panel 5. The operation amount processing unit 6 acquires the movement amount of the finger of the user on the screen of the touch panel 5 detected by the touch panel 5 as the operation amount.

In S13, the operation amount processing unit 6 calculates the converted operation amount based on the operation amount of the touch operation. The operation amount processing unit 6 converts the operation amount of the touch operation into the converted operation amount by multiplying the operation amount of the touch operation by a reciprocal of the normalization coefficient.

In S14, the operation amount processing unit 6 may acquire the operation speed of the touch operation. The operation amount processing unit 6 may acquire the movement speed of the finger of the user on the screen of the touch panel 5 detected by the touch panel 5 as the operation amount.

In S15, the operation amount processing unit 6 may acquire the operation intensity and the operation frequency of the touch operation. The operation amount processing unit 6 may recognize the pressure or the contact area of the finger detected by the touch panel 5 as the operation intensity. The operation amount processing unit 6 may detect the operation frequency at which the user repeatedly swipes the screen of the touch panel 5 in the same direction.

In S16, the ECU 10 may acquire the vehicle speed from the vehicle speed sensor 2 by the operation amount adjustment unit 12. In S17, the operation amount adjustment unit 12 may acquire the information related to the user. The ECU 10 may acquire the information such as the seating position or the line of sight of the user based on the information from the driver monitoring camera 3.

In S18, the ECU 10 adjusts the movement amount of the image within the screen by the operation amount adjustment unit 12. The operation amount adjustment unit 12 calculates an adjusted movement amount by multiplying the converted operation amount converted as described above by the operation amount processing unit 6 by the screen size coefficient, and adjusts the movement amount. The operation amount adjustment unit 12 may optimally adjust the movement amount of the image based on the acquired operation speed, operation intensity, operation frequency, vehicle speed, and information related to the user.

In S19, the ECU 10 causes the display control unit 13 to move the image within the screen by the movement amount that is adjusted. The display control unit 13 controls the touch panel 5 such that the image is moved within the screen of the touch panel 5 based on the adjusted movement amount. Thereafter, the ECU 10 ends the processing in FIG. 3. The ECU 10 may repeat the processing in FIG. 3 for each predetermined operation cycle.

In the display control device 100 described above, the movement amount of the images 22, 23 within the screen by the touch operation is adjusted to the adjusted movement amount based on the converted operation amount and the screen size of the touch panels 5b, 5c. As a result, even when the screen sizes of the touch panels 5b, 5c are different from the reference screen size of the touch panel 5a, the movement amount can be adjusted as follows. For example, the movement amount can be adjusted according to the screen sizes of touch panels 5b and 5c such that a sense of discomfort for the user is reduced, as compared with when the converted operation amount is used directly as the movement amount of the image within the screen. Therefore, according to the display control device 100, it is possible to suppress deterioration in operability that may occur due to the relationship between the physical movement amount of a finger on the screen surface and the movement amount of images 22, 23 within the screen of touch panel 5.

The operation amount adjustment unit 12 stores the screen size coefficient that is the correction coefficient proportional to the screen size of the touch panel 5, and adjusts the movement amount such that a value obtained by multiplying the converted operation amount by the screen size coefficient is the adjusted movement amount. As a result, the movement amount can be adjusted by simple calculation using the screen size coefficient.

The operation amount adjustment unit 12 sets the screen size coefficient to be small, when a magnitude of an operation speed of the touch operation is equal to or less than a speed threshold value that is predetermined, as compared with when the magnitude

of the operation speed is larger than the speed threshold value. As a result, by changing the adjusted movement amount according to the operation speed, the operability becomes closer to intuitive operability when the operation speed is fast, and fine adjustment becomes easier when the operation speed is slow.

The operation amount adjustment unit 12 sets the screen size coefficient to be small, when the operation intensity of the touch operation is larger than a predetermined intensity threshold value, as compared with when the operation intensity is equal to or less than the intensity threshold value. As a result, when the operation intensity is larger than the intensity threshold value, the movement amount of the image that moves within the screen becomes smaller, making fine adjustment easier.

The operation amount adjustment unit 12 sets the screen size coefficient to be large, when a magnitude of an operation frequency of the touch operation, in which the user repeatedly swipes a surface of the screen in the same direction, is larger than a frequency threshold value that is predetermined, as compared with when the operation frequency is equal to or less than the frequency threshold value. As a result, when the operation frequency is larger than the frequency threshold value, the movement amount of the image that moves within the screen becomes large. Therefore, it is possible to suppress the user from feeling stress in further repeating the swipe operation in the same direction and feeling difficulty in the operation or deterioration in the operability, as compared with when the movement amount is not set to be large.

Although the embodiments of the present disclosure have been described above, the present disclosure is not limited to the above-described embodiments. The present disclosure may be implemented in various forms with various changes and improvements based on the knowledge of those skilled in the art, beginning with the above-described embodiments.

In the above-described embodiments, the operation amount adjustment unit 12 optimally adjusts the movement amount of the image based on the acquired operation speed, operation intensity, operation frequency, vehicle speed, and information related to the user, but the present disclosure is not limited to this example. It may be omitted to base on some or all of these.

In the above-described embodiment, the operation amount adjustment unit 12 stores the screen size coefficient that is the correction coefficient proportional to the screen size of the touch panel 5, and adjusts the movement amount such that a value obtained by multiplying the converted operation amount by the screen size coefficient is the adjusted movement amount. However, the adjustment by the operation amount adjustment unit 12 is not limited to this example. The screen size coefficient may be a correction coefficient determined by a relationship other than proportionality with respect to the screen size of the touch panel 5. Instead of multiplying the converted operation amount by the screen size coefficient, the screen size correction value may be added to the converted operation amount.

In the above-described embodiments, the predetermined reference screen size is 10 inches, but may be another size. In addition, the relationship between the predetermined reference screen size and the screen size of the touch panel 5 may not be limited to a difference in inch size. For example, the relationship between the predetermined reference screen size and the screen size of the touch panel 5 may be a relationship in which a substantial difference in physical dimensions on the screen surface is produced due to a difference in aspect ratio or a difference in pixel density (dpi), or the like. In this case, by treating the dimension causing the substantial difference as the "screen size", the movement amount can be adjusted in the same manner as in the above-described disclosure.

In the above-described embodiments, the operation amount processing unit 6 that converts the operation amount of the touch operation into the converted operation amount is provided in the HMI 4, but the present disclosure is not limited to this example. The operation amount processing unit 6 may be one of the functional configurations of the ECU 10.

What is claimed is:

1. A display control device that is mounted on a vehicle and configured to control a display unit that receives a touch operation from a user of the vehicle, the display control device comprising:
an operation amount adjustment unit configured to adjust a movement amount of an image within a screen of the display unit by the touch operation based on a converted operation amount obtained by converting an operation amount of the touch operation according to a predetermined reference screen size and a screen size of the display unit; and
a display control unit configured to cause the display unit to display the image such that the image moves within the screen of the display unit according to the movement amount that is adjusted.

2. The display control device according to claim 1, wherein the operation amount adjustment unit is configured to
store a screen size coefficient that is a correction coefficient proportional to the screen size of the display unit, and
adjust the movement amount such that a value obtained by multiplying the converted operation amount by the screen size coefficient is the movement amount.

3. The display control device according to claim 2, wherein the operation amount adjustment unit is configured to set, when a magnitude of an operation speed of the touch operation is equal to or less than a speed threshold value that is predetermined, the screen size coefficient to be small, as compared with when the magnitude of the operation speed is larger than the speed threshold value.

4. The display control device according to claim 2, wherein the operation amount adjustment unit is configured to set, when a magnitude of an operation intensity of the touch operation is larger than an intensity threshold value that is predetermined, the screen size coefficient to be small, as compared with when the magnitude of the operation intensity is equal to or less than the intensity threshold value.

5. The display control device according to claim 2, wherein the operation amount adjustment unit is configured to set, when an operation frequency of the touch operation, in which the user repeatedly swipes a surface of the screen in the same direction, is larger than a frequency threshold value that is predetermined, the screen size coefficient to be large, as compared with when the operation frequency is equal to or less than the frequency threshold value.
